(19) United States
(12) Patent Application Publication
(10) Pub. No.: US 2014/0335323 A1
(43) Pub. Date: Nov. 13, 2014

(54) Laminate Structural Material

(71) Applicant: G.H.L. International, Inc., Cedarburg, WI (US)

(72) Inventor: John M. Lipscomb, Cedarburg, WI (US)

(21) Appl. No.: 14/339,449

(22) Filed: Jul. 23, 2014

Related U.S. Application Data
(63) Continuation-in-part of application No. 13/868,084, filed on Apr. 22, 2013.
Application No. 13/868,084 is a continuation of application No. 13/842,534, filed on Mar. 15, 2013.
Application No. 13/842,534 is a continuation-in-part of application No. 13/868,073, filed on Apr. 22, 2013.
(60) Provisional application No. 61/857,236, filed on Jul. 23, 2013.

(51) Int. Cl. B32B 3/28; B32B 7/02; B32B 23/06; B32B 7/12; B32B 29/08

(52) U.S. Cl. CPC B32B 3/28; B32B 7/12; B32B 29/08; B32B 23/06; B32B 7/02; B32B 2264/04; B32B 2305/30; B32B 2307/50; B32B 2307/7163; B32B 2307/734; B32B 2479/00
USPC 428/184; 428/532; 428/213; 428/535

(57) ABSTRACT

A laminate structural material including at least one substrate layer and at least one reinforcing layer. The reinforcing layer may include a binder and a starch-containing component. The reinforcing layer is made from a base material having discrete starch-containing pellets bound to each other by a carbohydrate polymer binder. The laminate structural material to be formed into components of furniture, shelters, enclosures, pet accessories, and/or other structures.

### CROSS REFERENCE

This application claims priority in U.S. Provisional Patent Application No. 61/857,236 filed Jul. 23, 2013 under 35 U.S.C. §119(e), and is a continuation-in-part of each of U.S. patent application Ser. No. 13/868,084 filed Apr. 22, 2013, U.S. patent application Ser. No. 13/868,073 filed Apr. 22, 2013, and U.S. patent application Ser. No. 13/842,534 filed Mar. 15, 2013, each of which claims priority in U.S. Provisional Patent Application No. 61/775,707 filed Mar. 11, 2013 and in U.S. Provisional Patent Application No. 61/699,858 filed Sep. 11, 2012 under 35 U.S.C. §119(e).

### FIELD

The present invention is directed to structural materials and, more particularly, to laminate structural materials well suited for use as a structural component used in construction, furniture-making, shelter-making, and other similar applications.

### BACKGROUND

It is growing increasingly popular to build structures, shelters, and the like using materials that can be readily recycled and which are made from natural or otherwise biodegradable materials. For example, pet furniture made from cardboard is gaining in popularity.

What is needed is a new structural material that is lightweight, strong, inexpensive and simple to make and use.

### SUMMARY

The present invention is directed to a laminate structural material that is strong, lightweight, easy to ship in unassembled or folded flat configurations, inexpensive, and biodegradable or otherwise recyclable. This may allow for using the laminate structural material to be formed into panels or other components of furniture, shelters, enclosures, pet accessories, and/or other structures.

One preferred laminate structural material is used for making pet furniture. One preferred laminate structural material is used for making residential or office furniture such as bookshelves or other shelving, tables, and the like. Another preferred laminate structural material is formed into panels that can be implemented as support components. Such panels can be connected to each other forming a structure such as an enclosure. One preferred enclosure formed of the laminate structural material panels is implemented as a temporary shelter such as a temporary shade shelter or windbreak shelter. Another preferred enclosure formed of the laminate structural material is implemented as a temporary emergency shelter or the like. One preferred enclosure formed of the laminate structural material is implemented as a temporary storage shelter or other storage enclosure. One preferred temporary shelter or other structure formed of the laminate structural material can be assembled on-site.

One preferred panel can be made on-site by an on-site forming of the laminate structural material. This can be done by wetting a surface of a substrate material and coating spray application of a base material having discrete starch-containing pellets to be bound to each other by a carbohydrate polymer binder onto the wetted substrate material. The application of the base material onto the wetted substrate material activates the forming of a substantially hard or rigid product as a reinforcing layer, during which the discrete starch-containing pellets bind to each other within the base material by the carbohydrate polymer binder during curing or drying, forming a laminate structural material in a panel configuration.

Another preferred panel is formed on-site or otherwise with a sandwiched configuration with the reinforcing layer in between a pair of substrate materials. This can be done by wetting a surface on each of a pair of substrate materials, coating the wetted substrate material with the base material having discrete starch-containing pellets bound to each other by a carbohydrate polymer binder that dries or cures between and adheres to each of the outwardly disposed substrate materials.

One preferred laminate structural material may include at least one substrate layer and a reinforcing layer. The reinforcing layer may include a binder and starch-containing components. The reinforcing layer may include discrete starch-containing pellets bound to each other by a binder such as a carbohydrate polymer binder. The carbohydrate polymer binder may be water soluble and may include dextrin. The structural material may include at least one cereal grain. The at least one cereal grain may be corn-based. The corn-based at least one cereal grain may include at least one of corn grits, corn meal, corn flour, and corn starch. The at least one substrate layer may include cardboard.

The structural material may include a pair of outer layers and a reinforcing layer arranged between the outer layers. The reinforcing layer may include a binder and at least one starch-containing component. The reinforcing layer may be made from a base material comprising discrete starch-containing pellets bound to each other by a carbohydrate polymer binder.

A structure such as a piece of pet furniture may be made from the laminate structural material. Other furniture, storage containers, and other structures being made from the laminate structural material. The structure may include a support component having the laminate structural material defining at least one outer layer and at least one reinforcing layer. The laminate structural material may include one or more pairs of outer layers and/or reinforcing layers, such as a plurality of pairs, i.e. three or more. One preferred laminate structural material may include a pair of outer layers and a reinforcing layer arranged between the outer layers. The reinforcing layer may be made from a base material that includes discrete starch-containing pellets bound to each other by a carbohydrate polymer binder. The base material from which the reinforcing layers is made may include discrete pellets such as starch-containing pellets bound to each other by a carbohydrate polymer binder. The carbohydrate polymer may be water soluble. The carbohydrate polymer binder may include dextrin. The pellets may be bound to each other with a binder having an acrylic material. Pellets may be bound to each other with a non-acrylic binder which may have a water-activated component. The base material may include a cellulosic material such as hay.

The laminate structural material may allow for use of natural materials that are readily biodegradable or otherwise recyclable, such as cardboard, paperboard, paper, wood, or another suitable substrate, with enhanced structural characteristics for use in making structures, including furniture for pets. This may allow for providing relatively large pieces of pet furniture that are substantially stable and durable by using cost-effective and non-toxic materials

The present invention also is directed to a laminate structural material that is strong, lightweight, easy to ship in unassembled or folded flat configurations, inexpensive, and biodegradable or otherwise recyclable. This may allow for using the laminate structural material to be formed into panels or other components of furniture, shelters, enclosures, pet accessories, and/or other structures.

One preferred laminate structural material has a pair of substrate layers and a layer of starch-containing granular material. The layer of starch-containing granular material can include a water soluble binder adhesively bonding the starch-containing granular material together between the substrate layers and adhesively bonding the substrate layers together.

In one preferred laminate structural material, the layer of adhesively bonded starch-containing granular material defines a reinforcing layer. The reinforcing layer can be between the pair of substrate layers to which the layer of adhesively bonded starch-containing granular material is bonded, which reinforces the pair of substrate layers. One preferred layer of adhesively bonded starch-containing granular material has a thickness of at least one-quarter the thickness of one of the pair of substrate layers and no greater than the combined thickness of the pair of substrate layers. The starch-containing granular material can have of a plurality of pairs of extruded granules or pellets having at least 20% water soluble binder content by granule or pellet weight. This provides sufficient water soluble binder when wetted to adhesively bond the granules or pellets together and to each one of the pair of substrate layers. The starch-containing granular material can have a plurality of pairs of extruded granules or pellets having at least 10% dextrin content by granule or pellet weight. This provides sufficient water soluble binder when wetted to adhesively bond the granules or pellets together and to each one of the pair of substrate layers.

One preferred reinforcing layer defined by the layer of adhesively bonded starch-containing granular material increases the crush strength of the laminate structural material beyond that of the crush strength of the pair of substrate layers without the layer of adhesively bonded starch-containing granular material. One preferred reinforcing layer defined by the layer of adhesively bonded starch-containing granular material increases the bending strength of the laminate structural material beyond that of the bending strength of the pair of substrate layers without the layer of adhesively bonded starch-containing granular material. One preferred reinforcing layer defined by the layer of adhesively bonded starch-containing granular material increases the bending strength of the laminate structural material beyond that of the bending strength of the pair of substrate layers without the layer of adhesively bonded starch-containing granular material.

In one preferred laminate structural material, the starch-containing granular material is comprised of a plurality of pairs of extruded granules or pellets having at least 15% dextrin content and at least 25% water soluble binder content by granule or pellet weight formed during pellet or granule extrusion providing sufficient water soluble binder when wetted with water to adhesively bond the granules or pellets together and to each one of the pair of substrate layers.

One preferred starch-containing granular material is comprised of a plurality of pairs of extruded granules or pellets extruded from an admixture comprised substantially of at least one starch-containing cereal grain. One preferred layer of adhesively bonded starch-containing granular material has a thickness of at least one-quarter the thickness of one of the pair of substrate layers and no greater than the combined thickness of the pair of substrate layers.

In one preferred laminate structural material, at least one of the pair of substrate layers is comprised of paperboard or cardboard. Each one of the pair of substrate layers can include comprised paperboard and/or cardboard. One preferred layer of adhesively bonded starch-containing granular material defines a reinforcing layer between the pair of substrate layers to which the layer of adhesively bonded starch-containing granular material is bonded reinforcing the pair of substrate layers. Each one of the pair of substrate layers can include a generally planar sheet of multi-ply corrugated paperboard or cardboard.

In one preferred laminate structural material, the starch-containing granular material is comprised of a plurality of pairs of extruded granules or pellets having at least 10% dextrin content and at least 20% water soluble binder content by granule or pellet weight formed during pellet or granule extrusion. This provides sufficient water soluble binder when wetted with water to adhesively bond the granules or pellets together and to each one of the pair of substrate layers. One preferred laminate structural material includes a starch-containing granular material that has plurality of pairs of extruded granules or pellets extruded from an admixture comprised substantially of at least one starch-containing cereal grain.

One preferred laminate structural material includes a pair of substrate layers and a layer of starch-containing granular material disposed between the substrate layers. The layer of starch-containing granular material disposed between the substrate layers can be adhesively bonded to the substrate layers. One preferred layer of starch-containing granular material is formed by adhesive bonding with water soluble binder from the starch-containing granular material. The layer of starch-containing granular material can define a reinforcing layer between the substrate layers.

In one preferred laminate structural material, the layer of starch-containing granular material has a thickness of at least one-quarter the thickness of one of the pair of substrate layers and no greater than the combined thickness of the pair of substrate layers. One preferred laminate structural material includes a starch-containing granular material that has a plurality of pairs of extruded granules or pellets having at least 20% water soluble binder content by granule or pellet weight. This provides sufficient water soluble binder when wetted to adhesively bond the granules or pellets together and to each one of the pair of substrate layers. The starch-containing granular material can include a plurality of pairs of extruded granules or pellets having at least 10% dextrin content by granule or pellet weight. This provides sufficient water soluble binder when wetted to adhesively bond the granules or pellets together and to each one of the pair of substrate layers. In one preferred laminate structural material, each one of the substrate layers includes a generally planar sheet of multi-ply corrugated paperboard or cardboard.

One preferred laminate structural material includes a pair of substrate layers, each formed of a generally planar sheet of cellulosic material. In one preferred laminate structural material, a layer of starch-containing granular material is disposed between the substrate layers and adhesively bonded to the substrate layers when wetted. The layer of starch-containing granular material formed by adhesive bonding with water soluble binder from the starch-containing granular material can be formed during extrusion of the starch-containing granular material. One preferred layer of starch-containing granular material defines a reinforcing layer between the substrate layers.

One preferred layer of the starch-containing granular material has a thickness of at least one-quarter the thickness of one of the pair of substrate layers and no greater than the combined thickness of the pair of substrate layers. One preferred starch-containing granular material includes a plurality of pairs of extruded granules or pellets having at least 10% dextrin content and at least 20% water soluble binder content by granule or pellet weight formed during pellet or granule extrusion providing sufficient water soluble binder when wetted with water. This can adhesively bond the granules or pellets together and to each one of the pair of substrate layers. In one preferred laminate structural material, each generally planar sheet of cellulosic material forms a generally planar sheet of multi-ply corrugated paperboard or cardboard.

One preferred laminate structural material is used for making pet furniture. One preferred laminate structural material is used for making residential or office furniture such as bookshelves or other shelving, tables, and the like. Another preferred laminate structural material is formed into panels that can be implemented as support components. Such panels can be connected to each other forming a structure such as an enclosure. One preferred enclosure formed of the laminate structural material panels is implemented as a temporary shelter such as a temporary shade shelter or windbreak shelter. Another preferred enclosure formed of the laminate structural material is implemented as a temporary emergency shelter or the like. One preferred enclosure formed of the laminate structural material is implemented as a temporary storage shelter or other storage enclosure. One preferred temporary shelter or other structure formed of the laminate structural material can be assembled on-site.

One preferred panel can be made on-site by an on-site forming of the laminate structural material. This can be done by wetting a surface of a substrate material and coating spray application of a base material having discrete starch-containing pellets to be bound to each other by a carbohydrate polymer binder onto the wetted substrate material. The application of the base material onto the wetted substrate material activates the forming of a substantially hard or rigid product as a reinforcing layer, during which the discrete starch-containing pellets bind to each other within the base material by the carbohydrate polymer binder during curing or drying, forming a laminate structural material in a panel configuration.

Another preferred panel is formed on-site or otherwise with a sandwiched configuration with the reinforcing layer in between a pair of substrate materials. This can be done by wetting a surface on each of a pair of substrate materials, coating the wetted substrate material with the base material having discrete starch-containing pellets bound to each other by a carbohydrate polymer binder that dries or cures between and adheres to each of the outwardly disposed substrate materials.

One preferred laminate structural material may include at least one substrate layer and a reinforcing layer. The reinforcing layer may include a binder and starch-containing components. The reinforcing layer may include discrete starch-containing pellets bound to each other by a binder such as a carbohydrate polymer binder. The carbohydrate polymer binder may be water soluble and may include dextrin. The structural material may include at least one cereal grain. The at least one cereal grain may be corn-based. The corn-based at least one cereal grain may include at least one of corn grits, corn meal, corn flour, and corn starch. The at least one substrate layer may include cardboard.

The structural material may include a pair of outer layers and a reinforcing layer arranged between the outer layers. The reinforcing layer may include a binder and at least one starch-containing component. The reinforcing layer may be made from a base material comprising discrete starch-containing pellets bound to each other by a carbohydrate polymer binder.

A structure such as a piece of pet furniture may be made from the laminate structural material. Other furniture, storage containers, and other structures being made from the laminate structural material. The structure may include a support component having the laminate structural material defining at least one outer layer and at least one reinforcing layer. The laminate structural material may include one or more pairs of outer layers and/or reinforcing layers, such as a plurality of pairs, i.e. three or more. One preferred laminate structural material may include a pair of outer layers and a reinforcing layer arranged between the outer layers. The reinforcing layer may be made from a base material that includes discrete starch-containing pellets bound to each other by a carbohydrate polymer binder. The base material from which the reinforcing layers is made may include discrete pellets such as starch-containing pellets bound to each other by a carbohydrate polymer binder. The carbohydrate polymer may be water soluble. The carbohydrate polymer binder may include dextrin. The pellets may be bound to each other with a binder having an acrylic material. Pellets may be bound to each other with a non-acrylic binder which may have a water-activated component. The base material may include a cellulosic material such as hay.

The laminate structural material may allow for use of natural materials that are readily biodegradable or otherwise recyclable, such as cardboard, paperboard, paper, wood, or another suitable substrate, with enhanced structural characteristics for use in making structures, including furniture for pets. This may allow for providing relatively large pieces of pet furniture that are substantially stable and durable by using cost-effective and non-toxic materials.

### DRAWING DESCRIPTION

Preferred exemplary embodiments of the invention are illustrated in the accompanying drawings in which like reference numerals represent like parts throughout, and in which:

FIG. 1 is a perspective view of an article or structure made from one or more panels of a laminate structural material constructed in accordance with the present invention;

FIG. 2 is an exploded view of a panel made of the laminate structural material;

FIG. 3 is an enlarged fragmentary and simplified cross-sectional view depicting preferred laminate structural material panel embodiments;

FIG. 4 is an enlarged transverse cross-sectional view of a preferred embodiment of a panel of the laminate structural material formed of outer substrate layers made of multi-ply corrugated paperboard or cardboard;

FIG. 5 is an enlarged longitudinal cross-sectional view of the preferred laminate structural material panel embodiment of FIG. 4; and

FIG. 6 is a flowchart showing a preferred method of making a panel of laminate structural material in accordance with the present invention.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

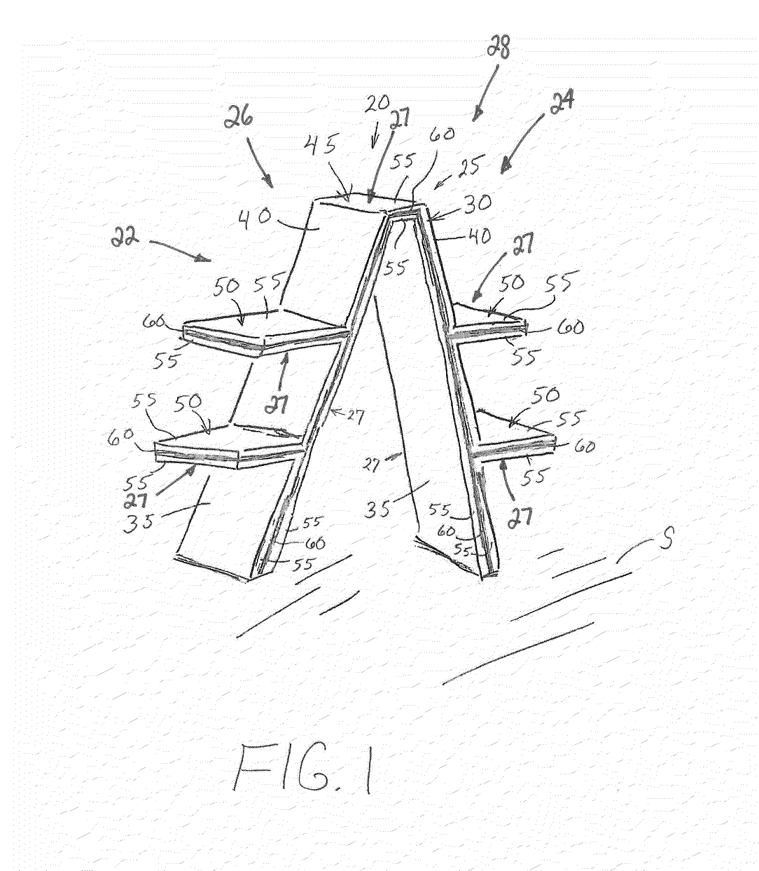

FIG. 1 illustrates an exemplary embodiment of an article of manufacture 20 that is a structure 22 made using one or more panels 27 made of a laminate structural material 30 constructed in accordance with the present invention formed of at least one substrate layer 55 reinforced by a laminate panel reinforcing layer 60 of a starch-containing granular material having a water soluble binder that bonds to the substrate layer 55 when wetted. The structure 22 shown in FIG. 1 is a piece of furniture 24 formed of a plurality of panels 27 of the laminate structural material 30 that is a piece of pet furniture 26 that preferably is a cat perch or cat perch tower 28. Although panels 27 formed of laminate structural material 30 of the present invention are well suited for use in making structures 22 like furniture 24, including pet furniture 26, the laminate structural material 30 of the invention, as well as panels 27 made of the laminate structural material 30 of the invention, are well suited for making virtually any other type of structure, including other types of furniture, wall or structural panels, enclosures, containers, sheds, shelters, buildings, and the like.

The structure 22, in this case furniture 25, includes at least one laminate panel 27, and preferably is made of a plurality of laminate panels 27, which define at least one support component that provides structural support thereto. The furniture 25 has a pair of uprights 35 that function as weight bearing or load bearing support components that extend upwardly from an underlying support surface “S” upon which the furniture 25 rests. Uprights 35 angle toward each other forming an A-frame and/or an inverted V-shaped furniture frame. Upper ends 40 of the uprights 35 are interconnected by an upper platform 45.

In one preferred embodiment, the uprights 35 and upper platform 45 are formed of a single elongate laminate panel 27 that is formed into the A-frame shown in FIG. 1 while the reinforcing layer 60 is still in a compliant or formable state, such as when still wet and/or still undergoing curing during or after making of the panel 27. In another preferred embodiment, each one of the uprights 35 is formed of a separate laminate panel 27 and the upper platform 45 is also formed of a separate panel 27. Where formed of separate laminate panels 27, the panels 27 can be joined or connected together conventionally, such as with hardware, fasteners, tape, caulk, or the like, but also can be joined to one another via a reinforcing layer 60 of one or more of the panels 27. Where the reinforcing layer 60 of one or more of the panels 27 is used to join the panels 27 of the uprights 35 and upper platform 45, it preferably is done while the reinforcing layer 60 of each such panel 27 used to join to another panel 27 is still in a compliant or formable state, such as when still wet and/or still undergoing curing.

Multiple shelves 50 cantilever outwardly from the uprights 35 and are spaced from each other along a height of the furniture 25 providing a plurality of outwardly extending pet supporting platforms upon which a cat can sit, stand, rest or lay. Platform 45 and shelves 50 are additional structural support components that are arranged to provide climbing structure and/or supports upon which a pet, such as a cat, may rest. In one preferred piece of furniture 25, each one of the uprights 35, platform 45, and shelves 50 are shown as being made from the laminate structural material 30. In another preferred piece of furniture 25, some of the piece of furniture 25 but not the entire piece of furniture 25 is made from the laminate structural material 30, such as at least one but fewer than all of the uprights 35, platform 45, and shelves 50 being made from the laminate structural material 30.

With reference to FIGS. 1-3, it should be apparent that a plurality of pairs of panels 27, i.e., at least three panels, each made of laminate structural material 30 in accordance with the present invention can be arranged in a manner similar to that discuss above with regard to the pet furniture 26 shown in FIG. 1 to form an enclosure, such as a box, a shelter, such as a temporary or emergency shelter, a shed, such as a storage shed, or another enclosure-type structure. Where at least a plurality of laminate panels 27 are arranged to form a box, at least five generally rectangular, e.g., square, panels 27 are arranged such that four of the panels 27 forming sides of the box and another one of the panels 27 forming a bottom of the box. Where at least a plurality of laminate panels 27 are arranged to form a building, e.g. shelter, at least five generally rectangular, e.g., square, panels 27 are arranged such that four of the panels 27 forming sides of the building and at least one of the panels 27 forms a top or roof of the building. The panels 27 can be joined or connected together conventionally, such as with hardware, fasteners, tape, caulk, or the like, but also can be joined to one another via a reinforcing layer 60 of one or more of the panels 27 such as when compliant or formable in accordance with that discussed above.

As such, one preferred structure 20 includes laminate panels 27 connected to each other forming a structure such as an enclosure. One preferred enclosure-type structure 20 formed of panels 27 can be implemented as a temporary shelter, such as a temporary shade shelter or windbreak shelter. Another preferred enclosure-type structure 20 formed of the panels 27 can be implemented as a temporary emergency shelter or the like. One preferred structure 20 formed of the panels 27 can be implemented as a temporary storage shelter or other storage enclosure.

An advantage of the present invention that should become readily apparent hereinbelow is that a plurality of pairs of substrate layers 55 can be shipped along with the starch-containing granular material used to make the reinforcing layer anywhere it is desired to build any suitable structure 22 and the panels 27 of laminate structural material 30 can be made on site as discussed below. As discussed in more detail below, the number or amount of panels 27 needed or desired to make a particular structure can be and preferably is produced by applying starch-containing granular material to, on or along an outer surface of at least one substrate layer 55 being used to form a panel 27 that is wetted, preferably with water, to cause water soluble binder in the starch-containing granular material to bond not only to itself to form the laminate panel reinforcing layer 60 but to also bond to the outer surface of each substrate layer 55 used to form the panel 27.

As the wetted starch-containing granular material dries, the binder cures thereby bonding it together forming the reinforcing layer 60 and bonding it to the surface of each substrate layer 55 of the panel producing a substantially rigid multi-layer laminate panel 27 having improved bending strength compared to a panel made solely of a single substrate layer 55 or a pair of the substrate layers 55. Once cured, where the panel 27 is formed of a plurality of substrate layers 55, the laminate panel reinforcing layer 60 is sandwiched therebetween holding fixing the substrate layers 55 thereto while also reinforcing the panel 27 by increasing its structural rigidity as compared to a panel made solely of a single substrate layer 55 or a pair of substrate layers 55. In at least one preferred laminate panel embodiment, reinforcing layer 60 not only increases the bending strength of the panel 27, it also increases its tensile strength, torsion strength, compressive strength, and shear strength as compared to a panel made solely of a single substrate layer 55 or a pair of substrate layers 55.

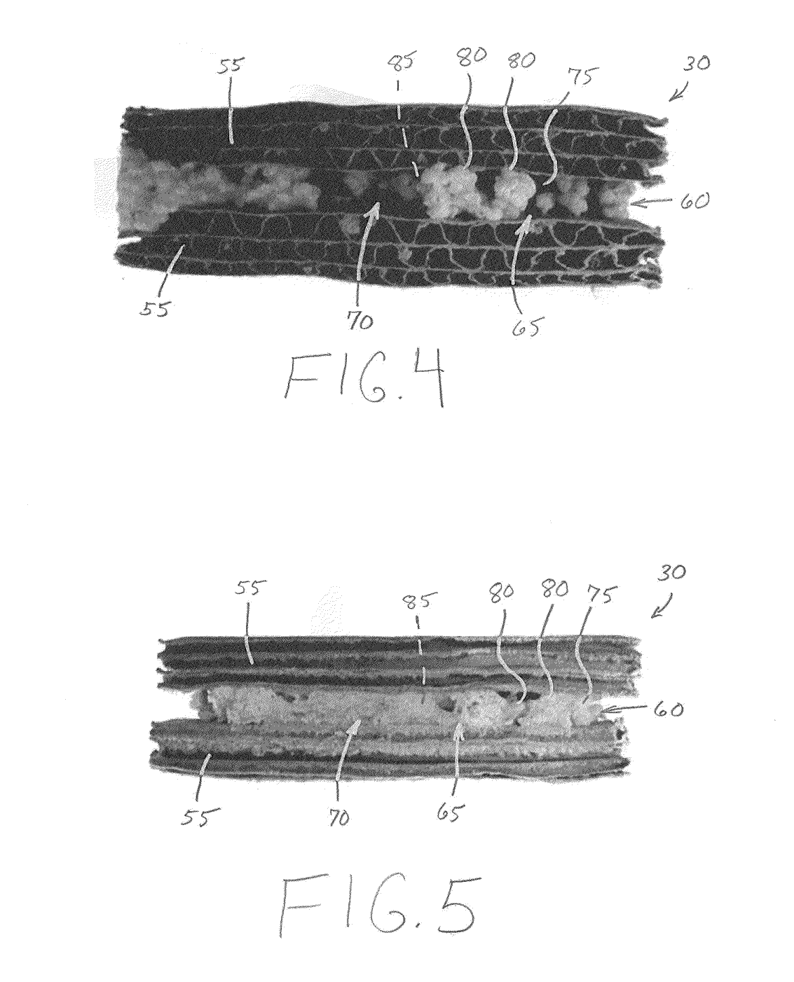

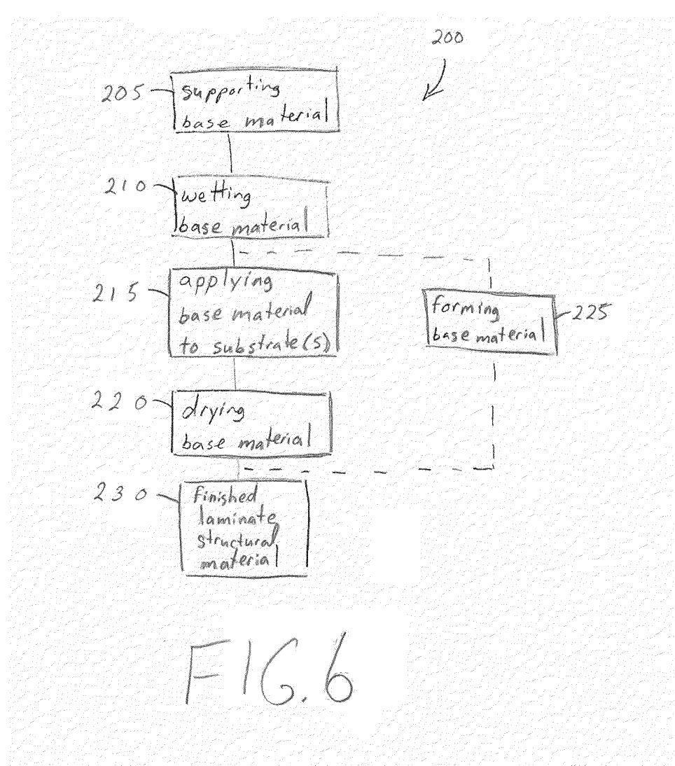

Referring now to FIGS. 1-5, the laminate structural material 30 may include at least one substrate layer 55 and at least one laminate panel reinforcing layer 60. The substrate layer(s) 55 is preferably made from a natural material that is readily biodegradable or otherwise recyclable, such as a cellulosic material like cardboard, paperboard, fiber board, wood, or another suitable substrate. In one preferred laminate panel embodiment, the laminate structure material 30 is formed of a single substrate layer 55 made of a multi-ply corrugated paperboard or cardboard to which the reinforcing layer 60 is applied. In another preferred laminate panel embodiment, the laminate structure material 30 is formed of a pair of substrate layer 55 made of a multi-ply corrugated paperboard or cardboard between which the reinforcing layer 60 is sandwiched.

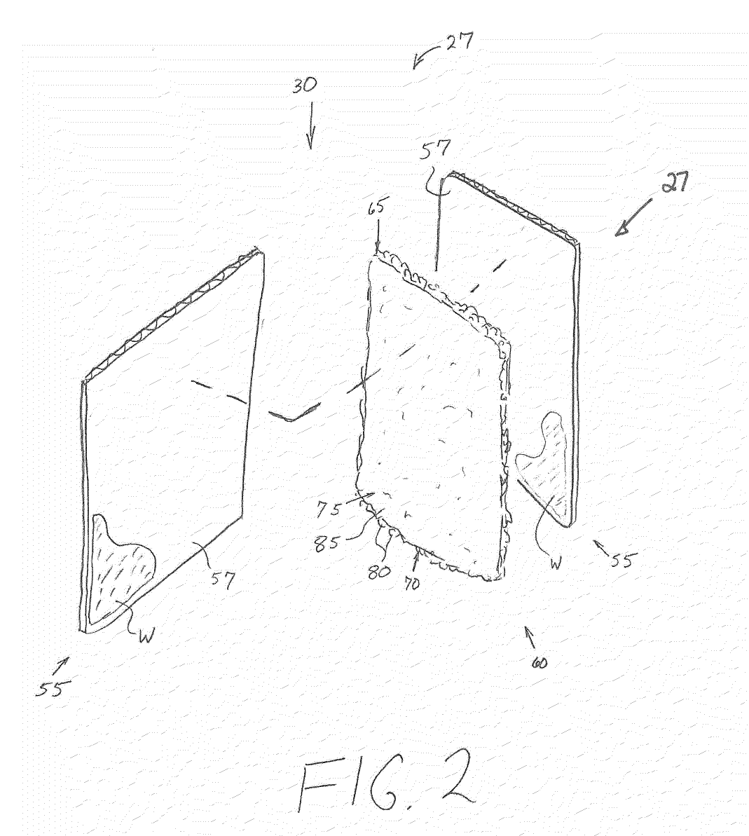

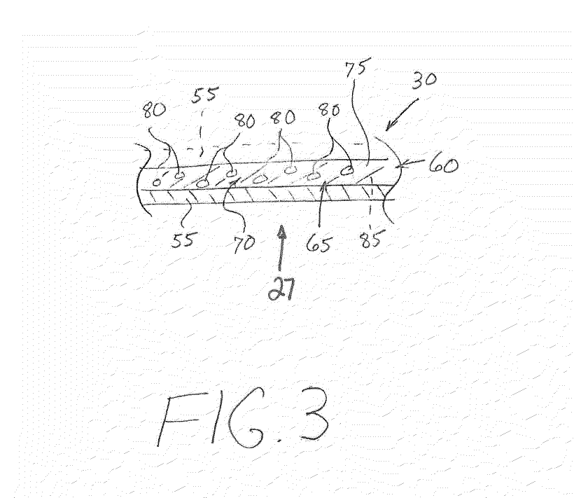

Referring now to FIGS. 2-5, a preferred laminate panel reinforcing layer 60 is a substantially rigid reinforcing product 65 produced from a spreadable or formable agglomerated or clumped mass 70 formed of a base material 75 that includes granular constituents, such as discrete starch-containing granules or pellets, shown as pellets 80 in FIG. 3, which are bound or adhered to each other by a binder 85 when wetted. The binder 85 can and preferably does define a continuous phase of material in which the pellets 80 can become embedded dissolve, and/or can merge with one another when wetted to form a substantially homogenous reinforcing layer 60 lacking individually discernible granules or pellets. The binder 85 can be and preferably is formed at least in part of a carbohydrate polymer binder. The carbohydrate polymer binder may be and preferably is water soluble and may include dextrin, which is a type of water soluble binder.

In a preferred embodiment, carbohydrate binder used to produce a formable reinforcing layer mass 70 from wetted base material 75 is water soluble. In one such preferred embodiment, the carbohydrate binder 85 used to form the agglomerated mass 70 defines a substantially hard or rigid product as the rigid reinforcing product 65 is water soluble and formed substantially of dextrin. The agglomerated mass 70 that turns into the laminate panel reinforcing layer 60 as the wetted base material 75 cures may include a cellulosic material, e.g. cellulose containing material, such as alfalfa or other hay, wood fiber, rice husks, paper, beet pulp, a water insoluble fiber, or the like having at least 25% cellulose by dry weight as a component of the pellets 80 or as an ancillary fibrous constituent. The laminate panel reinforcing layer 60 may be formed from at least one cereal grain that may be corn-based. The corn-based cereal grain may include at least one of corn grits, corn meal, corn flour, and corn starch.

Other suitable materials from which the base material 75 used to produce the agglomerated mass 70 when the base material 75 is wetted can be formed include one or more other cereal grains such as rice, wheat, triticale, amaranth, and/or sorghum. Where rice is used, the rice, preferably, is a form of ground rice that can be rice grits, rice meal, rice flour, and/or rice starch. Where wheat is used, the wheat, preferably, is a form of ground wheat that can be wheat grits, wheat meal, wheat flour, and/or wheat starch. Where triticale is used, the triticale, preferably, is a form of ground triticale that can be triticale grits, triticale meal, triticale flour, and/or triticale starch. Where amaranth is used, the amaranth, preferably, is a form of ground amaranth that can be amaranth grits, amaranth meal, amaranth flour, and/or amaranth starch. Where sorghum is used, the sorghum, preferably, is a form of ground sorghum that can be sorghum grits, sorghum meal, sorghum flour, and/or sorghum starch. The base material 75 can be made of a single ground cereal grain, a plurality of the aforementioned ground cereal grains, or even a plurality of pairs, i.e., at least three, of the above-identified ground cereal grains.

Still referring to FIGS. 2-5, in a preferred embodiment, the reinforcing layer 60 is formed from a granular base material 75 comprised of a plurality of pairs, i.e. at least three, of pellets 80 of an organic material that can be formed, at least in part, of ground cereal grain(s), such as corn or maize, rice, wheat, triticale, amaranth, and/or sorghum, which preferably is ground such as into meal, grits, flour and/or starch that can be extruded under pressure into particles comprising the pellets. As explained in greater detail elsewhere herein, the pellets 80, e.g. base material 75, are wetted, such as with a liquid wetting agent, that flows between pellets 80 and which can even be absorbed into some of the pellets 80 causing a plurality of the pellets 80 to bond together producing a relatively tacky wetted reinforcing layer 60 that can be disposed in contact, such as by being pressed or otherwise formed against at least one of the substrate layers 55 and allowed to set or cure by drying thereby becoming solid and adhering to the at least one substrate layer 55. In a preferred embodiment, the reinforcing layer 60 is sandwiched between a pair of substrate layers 55 while wet and/or tacky such that setting or curing of the reinforcing layer 60 formed of at least a plurality of pairs, i.e., at least three, of pellets 80 that have bonded together, became adhered to one another, and dried hardening into a relatively solid reinforcing layer that not only provides structural support to the laminate structure 30 but which also acts as an attachment layer that keeps each respective substrate layer 55 in contact the reinforcing layer 60 as attached, adhered, and/or bonded to the reinforcing layer 60. In another preferred embodiment, as explained in greater detail elsewhere herein, the pellets 80 of the base material 75 used to produce the reinforcing layer 60 are of self-clumping construction by being formed into pellets 80 extruded under sufficient pressure and temperature that each pellet contains a carbohydrate polymer binder that flows in and around a plurality of pellets 80 during a wetting step when a liquid wetting step is applied to the pellets 80 to wet them to make them tacky in causing the pellets to stick or clump together as part of the process or method in accordance with the present invention of making such a reinforcing layer 60 that not only provides an interior layer stronger than at least one if not all of the substrate layers 55 but which also causes each substrate layer 55 in contact therewith to become fixed to the reinforcing layer 60 when the reinforcing layer 60 sets or cures such as when it dries.

In one preferred implementation of a method of making a laminate structural material 30 in accordance with the present invention, the liquid wetting agent includes water or is water-based in order to solubilize carbohydrate polymer binder from at least a plurality of the pellets the wetting agent comes into contact with during the wetting step. When the carbohydrate polymer binder solubilizes or at least partially dissolves in the wetting agent applied to the pellets during the wetting step, it is able to flow in and around a plurality of other pellets adjacent to the pellet from which the solubilized carbohydrate polymer binder is provided. This enables the wetting agent to distribute carbohydrate polymer binder found in the self-clumping or self-adhering pellets 80 through at least a plurality of adjacent pellets causing them to clump together during the wetting step and thereafter causing them to become glued or fixed together when the carbohydrate polymer binder sets or cures. In one such preferred method implementation, setting or curing of the carbohydrate polymer binder occurs during drying of the pellets 80 after being wetted during the wetting step.

In one preferred method implementation, the wetting agent includes an adhesive that helps facilitate clumping and fixing of the pellets 80 during the wetting and setting/curing steps. One preferred wetting agent is formed of water containing a water-soluble adhesive different than the adhesive formed in a plurality of pellets 80 during pellet extrusion. The water-soluble adhesive preferably is added in an amount where the adhesive dissolves in the water wetting agent but allows the wetting agent to flow substantially like water when applied to the pellets 80 used to form the reinforcing layer 60 during the wetting step. In one preferred wetting agent embodiment, the adhesive containing water-based wetting agent contains an amount of adhesive dissolved in the wetting agent less than the amount which causes the viscosity of the wetting agent to increase to a viscosity 25% greater or thicker than the viscosity of water. In another preferred wetting agent embodiment, the wetting agent contains no more than 25% adhesive by wetting agent weight. In still another preferred wetting agent embodiment, the wetting agent contains no more than 15% adhesive by wetting agent weight. In a still further preferred wetting agent embodiment, the wetting agent contains no more than 10% adhesive by wetting agent weight. One preferred adhesive is an acrylic-based and/or an acrylic resin based adhesive that preferably is of water soluble composition and which works in concert with any carbohydrate polymer binder present in any of the pellets wetted by the wetting agent during the method of making the reinforcing layer 60. One preferred acrylic-based and/or acrylic resin based adhesive is an adhesive formed of and/or which includes polyvinyl acetate, explained in greater detail elsewhere herein, which is added to a water-based wetting agent that is applied to pellets during the wetting step to cause the wetting agent to not only distribute the acrylic-based and/or acrylic resin based adhesive on and around a plurality of pairs, i.e., at least three, of the pellets 80 clumping or sticking them together while producing a tacky exterior that will stick to any substrate layer 55 contacting the wetted reinforcing layer 60.

Such an adhesive-containing water-based wetting agent can be used with organic and/or biodegradable pellets of plant and/or cellulosic composition that lack any carbohydrate polymer binder (or lack any significant amount of any carbohydrate polymer binder) but is well suited for use with such pellets of self-clumping composition that contain carbohydrate polymer binder that can be and/or include dextrin formed during the making of the pellets. Such pellets can be of self-clumping construction or composition, with each pellet 80 containing carbohydrate polymer binder at least some of which solubilizes or dissolves in adhesive-containing water-based wetting agent wetting the pellets during the wetting step. The two adhesives flow with the wetting agent during the wetting step in and around the pellets 80 wetting them and causing at least a portion of each pellet 80 to become coated and/or absorb some of at least one of the adhesives and preferably some of each type of adhesive carried by the wetting agent. The two different adhesives work together to better coat and/or penetrate each pellet 80 wetted by the wetting agent causing the pellets 80 to become substantially immovably fixed together during the setting or curing step producing a reinforcing layer 60 that is not only solid but which also is substantially rigid, load bearing and which tightly holds the pair of substrate layers 55 contacting the reinforcing layer 60 fixing them in place sandwiching the reinforcing layer 60 between them, acting as a unitary amalgamation defining the laminate structural material 30.

In one such preferred method of making laminate structural material in accordance with the present invention, the setting or curing step is carried out during the drying of the wetted pellets 80 during and/or after the wetting step has been carried out. During the drying step, the liquid of the wetting agent can be allowed to evaporate by air drying, via application of heat and/or convection to accelerate drying and reduce drying time, and/or via application of a curing agent that helps expedite setting or curing of the adhesive(s) distributed substantially completely throughout the pellets 80 of the reinforcing layer 60 during the wetting step including by expediting the rate of drying to reduce drying time.

While each substrate layer 55 shown in the drawings is formed of cardboard, e.g., a corrugated material such as corrugated cardboard, other materials such as medium density fiberboard, particle board, pressboard, or another type of sheet or panel building or packaging material. While an acrylic-based or acrylic resin based glue is preferred for the liquid wetting agent, other types of glues including epoxies, phenolic-based adhesives and the like can also be added to the liquid wetting agent. To help facilitate bonding of each substrate layer 55 in contact with the reinforcing layer 60, pressure can be applied to one or both sides of the laminate structural material 30. The result is a lightweight, strong, inexpensive and easy to build sheet or panel type laminate structural material 30.

Referring now to FIG. 6, as a general overview that is explained in greater detail elsewhere herein, the laminate structural material may be formed as represented by process 200. As represented at block 205, the base material is supported. This may be done by way of holding a volume of the base material in a container that facilitates pouring. As represented at block 210, the base material is wetted. Water may be used to wet the base material for embodiments in which the base material includes water-activated clumping agents, adhesives, or binders. The wetting may include adding adhesives or binders to the base material. As represented at block 215, the wetted base material is applied to a first substrate and may be covered by a second substrate to provide a sandwiched arrangement of a reinforcing layer between a pair of substrate layers. As represented at block 220, the base material is dried so as to set the adhesive or binder for bonding pellets of the base material against each other to create a hardened reinforcing layer. As represented at block 225, forming may be done by shaping the base material while in a wetted state and/or dried state. The forming may include compressing or molding the base material, or otherwise mechanically shaping the base material or substrates so as to form the laminate structural material represented in a finished state at block 230.

Still referring to FIG. 6, one laminate structural material 30 (FIGS. 2-5) include forming the rigid reinforcing product 65 a process having wetting, forming, applying, drying, and producing or finishing procedures utilizing pellets 80 as constituents. Still referring to FIG. 6, as represented at block 205, the base material is supported, for example, by way of receiving and retaining a volume of the base material in a container which may define a mold that forms the clumped mass 70 into a corresponding desired shape of the desired end-use form of the reinforcing layer 60 within the laminate structural material 30. Where a mold is used, the mold has a mold cavity in which a volume of the base material is filled and held during a clumping and binding step of the process 200. Where the size and/or shape of rigid reinforcing product 65 is not critical, base material may be formed into a clumped mass 70 in the same manner discussed below that is also applicable to when a mold is employed.

Still referring to FIG. 6, as represented at block 210, the base material 75 (FIGS. 2-5) is wetted by a liquid wetting agent during a wetting step of the process causing at least some of the base material to clump together during a clumping step that can occur substantially simultaneously with the wetting step and/or immediately following the wetting step and which can continue for a period of time after the wetting step is completed. In a preferred implementation of process 200, wetting agent is applied to a base material formed of at least a plurality of pairs, i.e., at least three, of pellets 80 at least partially formed of one or more of the aforementioned ground cereal grains wetting at least a plurality of pairs of the pellets causing at least a plurality of the pellets to clump together in forming a clumped mass 70 that becomes a rigid product 65 when setting occurs which can be cut, machined, or otherwise posting cured formed into a desired configuration corresponding to the end-use form of the laminate structural material 30.

During the wetting step, the liquid wetting agent flows in and around the plurality of pairs of pellets causing a carbohydrate polymer binder formed during the production of the base material, e.g., during extrusion of pellets of the base material, to at least partially dissolve and/or flow with the wetting agent between a plurality of pairs of the pellets of the base material causing them to clump together. In a preferred implementation of the process, clumping occurs by at least a plurality of the pellets of the base material sticking together such as by adhesive forces, e.g., atomic and/or subatomic, e.g., Van Der Waals, ionic, or another form of adhesion, causing the plurality of pairs of pellets to form a clump that is the clumped mass 70.

Setting occurs immediately after clump formation and can begin during clump formation when clumping of at least a plurality of the pellets of the base material that forms the clumped mass 70 occurs. Setting occurs as the clumped mass 70 dries causing it to harden into the rigid product 65. During the setting step, at least the carbohydrate polymer binder hardens binding and/or fixing the plurality of pairs of pellets of the base material clumped together into a solid mass forming the rigid product 65. When setting and/or drying of the clumped mass 70 is completed, the resultant substantially hard and rigid product 65 formed is a substantially solid mass that cannot be easily broken, is biodegradable, safely support and are substantially heavier than the laminate structural material 30 itself, for example, able to support objects at least about three-times the weight of the laminate structural material 30, preferably at least about five-times or at least about ten-times the weight of the laminate structural material 30, and more preferably at least about twenty-times the weight of the laminate structural material 30.

In another preferred implementation of the process 200, the wetting agent contains an adhesive that preferably is a water-soluble adhesive that flows between at least a plurality of pellets of the base material during the wetting step causing the pellets to clump together forming the clumped mass 70. During the drying or setting step, the clumped pellets of the clumped mass 70 become glued or fixed to one another producing a solid mass that is the rigid product 65.

One preferred wetting agent is a water-soluble acrylic resin-based adhesive that, preferably, is comprised of polyvinyl acetate that can be in the form of an emulsion of polyvinyl acetate, such wood glue, carpenter's glue, school glue, ELMERS GLUE, or the like. In a preferred wetting agent where an adhesive formed of an emulsion of polyvinyl acetate is used, such a wetting agent, preferably, is water-based containing no more than 20% polyvinyl acetate by weight of the wetting agent and, preferably, contains between 0.5% and 10% polyvinyl acetate. In another such preferred wetting agent, the wetting agent has between about 1% and 7% polyvinyl acetate by weight with the rest of the wetting agent formed of water or at least 50% water where the wetting agent includes other additional additives or constituents. Where polyvinyl acetate is used, it can be added in the form of an emulsion and/or mixed with water in the wetting agent to form an emulsion if an emulsion is desired.

Another preferred wetting agent is a protein-based adhesive, such as a casein-based and/or casein adhesive, which can be added in the form of an emulsion and/or mixed with water in the wetting agent to form an emulsion, if desired. In a preferred wetting agent containing a protein-based adhesive, e.g., a casein-based and/or casein adhesive, the wetting agent preferably contains no more than 20% protein-based adhesive by weight of the wetting agent and preferably contains between 0.5% and 10% protein-based adhesive. In another such preferred wetting agent, the wetting agent has between about 1% and 7% protein-based adhesive by weight with the rest of the wetting agent formed of water or at least 50% water where the wetting agent includes other additional additives or constituents.

Where the wetting agent includes an adhesive or binder, the base material need not include any carbohydrate polymer binder but preferably is pelletized. A plurality of pairs of pellets, i.e., at least three pellets, and preferably more than 10 pellets, are wetted during the wetting step with an adhesive containing liquid wetting agent, such as a water-based wetting agent composed or configured in accordance with that disclosed herein. The more than 10 pellets (base material) can be received and retained in a cavity of a mold during the wetting step or can be located in contact with one another, such as by being in a pile or mound, such as on a surface that can be a flat surface, or disposed in a container, such as a bag, bucket, cup, etc. During the wetting step, adhesive in the wetting agent flows in between the outer surfaces of the pellets 80 wetting them and coating them. Where the pellets 80 are porous, at least some of the wetting agent, including at least some adhesive contained in the wetting agent, is absorbed into at least a plurality of the pellets.

In another preferred rigid product embodiment and implementation of process 200, the base material 75 has at least 10 pellets with at least a plurality of pairs of the pellets, i.e., at least three, containing an adhesive and/or binder that can be formed during pellet production and/or which can be added to the pellets during and/or after pellet production (such as during a coating, dusting, plating, mixing, and/or agglomerating step(s) where the adhesive and/or binder is added to the pellets post production). In one embodiment, each pellet is manufactured in a manner that forms at least some adhesive and/or binder at least some of which is exteriorly disposed and/or forms part of the outer surface of each pellet. During the wetting step, the wetting agent solubilizes at least some of the adhesive and/or binder present in and/or on each pellet of at least a plurality of pellets of the at least 10 pellets (base material) causing the solubilized adhesive to flow in between a plurality of pairs of the pellets of the at least 10 pellets causing at least those pellets to clump together forming the clumped mass 70 that ultimately holds together the at least 10 pellets throughout the setting step producing a rigid product 65 having at least 10 pellets substantially permanently fixed together by the adhesive.

Still referring to FIG. 6, as outer surfaces of at least a plurality of the pellets of the at least 10 pellets (base material) become wetted with the wetting agent and, preferably, at least partially coated with adhesive during wetting, clumping begins to occur. During the clumping step, at least a plurality of pairs, i.e., at least three, of the pellets of the at least 10 pellets (base material) begin to adhere or stick to one another when wetted during the wetting step causing them to clump together. When the clumping step is completed, at least a plurality of pairs of the pellets of the at least 10 pellets (base material) clump together forming a clumped mass 70 that includes or holds together the at least 10 pellets (base material) thereby forming a substantially hard and rigid product 65 that is substantially dry that is formed of at least 10 pellets when the setting step is completed.

Still referring to FIG. 6, as represented at block 215, base material is applied to the substrate. This can be done by spraying, brushing, rolling, or otherwise apply the wetted base material to respective surfaces of the substrate. As represented at block 220, the base material is dried so as to set the adhesive or binder for bonding pellets of the base material to each other and also to the substrate materials during the setting step. In another preferred embodiment, the wetted base material is dried on its own and subsequently adhered or otherwise affixed to the substrate material(s). As represented at block 225, forming may be done by shaping the base material while in a wetted state and/or dried state. Where such shaping or forming of the base material is done, it preferably is done before the setting step is completed. The forming may include compressing or molding the base material, or otherwise mechanically shaping the base material so as to form the substantially hard and rigid product 65, which may include simultaneously forming the substrate materials, into a desired shape or form, represented in a finished state at block 230.

One preferred rigid product is made by way of a process having wetting, forming, drying, and producing or finishing procedures utilizing various pellets as constituents formed of an admixture of granular constituents or granular embodiments, which may include discrete starch-containing extruded pellets that can be bound or adhered to each other by a binder formed in the extruded pellets during extrusion and/or by extrusion. One preferred form of the pellets is made by pellet extrusion or extrusion cooking using a single screw or twin screw extruder that can be an extruder operating at a horsepower of at least 25 horsepower and, preferably, at least 40 horsepower to produce the extruded pellets. In one preferred method, the extruder is operated at an extrusion pressure of at least about 800 PSI and preferably at least about 1,000 PSI at an extrusion temperature of at least 130° C. and preferably at least about 140° C. producing starch containing pellets or granules in which water soluble binder is formed during or by extrusion. The extruder can force the admixture material through bores in an orifice plate or die plate of the extruder with a cutter disposed at an outlet end of the orifice or die plate that cuts the extruded material, the extrudate, into pieces defining the pellets. This can form the pellets into various shapes including round, oval, oblong, cup-shaped, or the like, having sizes that can be about 1 cm×1 cm or smaller such as about 6 mm×6 mm or preferably no greater than about 3 mm×3 mm and various ones of height, width, and length dimensions. In one preferred embodiment, pellets having a width or diameter no greater than about 1 mm are formed that preferably also have a length no greater than 1 mm that can be cylindrical, oblong, spherical, round, half-moon shaped, cup-shaped, convexly shaped, concavely shaped or which have another suitable shaped.

One preferred form of the pellets defines pellets or granules made from a starch-based or starch-containing admixture that can be formed of at least one cereal grain and/or a water insoluble fiber that is gelatinized by the extruder and extruded from the extruder as an extrudate at a sufficiently high extrusion rate that produces at least a plurality of pairs, i.e., at least three, pellets or granules such as pellets from the extrudate per second when the extrudate discharged from the extruder is cut by a rotary knife or cutter of the extruder. Each extruded pellet or granule can be round or spherical, such as the generally round or substantially spherical granule, cupped or concave, or half-moon or crescent shaped.

One preferred admixture for forming the pellets has a relatively high starch content of at least 30% by total admixture weight and a low moisture content of no more than about 24% and preferably between 7% and 23% and more preferably between 8% and 21% or no more that about 18% and preferably no more than about 15% by total admixture weight including the moisture content and/or water in the dry admixture as well as any water added to the admixture. Extruding such a low moisture content high starch containing admixture produces pellets or granules having at least 23% starch by pellet or granule weight that preferably have at least 25% starch by pellet or granule weight dextrinizing starch in the admixture during extrusion producing pellets or granules having at least 1% dextrin by pellet or granule weight that preferably have at least 5% dextrin by pellet or granule weight. In a preferred embodiment, extruding such a low moisture content high starch containing admixture produces pellets or granules that form the base material from which clumps 70 are formed in the manner described hereinabove where the as-extruded pellets or granules have at least 25% starch by pellet or granule weight that preferably have at least 40% starch by pellet or granule weight dextrinizing starch in the admixture during extrusion producing pellets or granules having at least 8% dextrin by pellet or granule weight that preferably have at least 10% dextrin by pellet or granule weight. In still another preferred embodiment, extruding such a low moisture content high starch containing admixture produces pellets or granules used as base material where the pellets or granules have at least 35% starch by pellet or granule weight that preferably have at least 45% starch by pellet or granule weight dextrinizing starch in the admixture during extrusion producing pellets or granules having at least 12% dextrin by pellet or granule weight that preferably have at least 15% dextrin by pellet or granule weight. In a further preferred embodiment, extruding such a low moisture content high starch containing admixture produces pellets or granules used as base material with the pellets or granules having at least 40% starch by pellet or granule weight that preferably have at least 50% starch by pellet or granule weight dextrinizing starch in the admixture during extrusion producing pellets or granules having at least 18% dextrin by pellet or granule weight that preferably have at least 25% dextrin by pellet or granule weight. In a still further preferred embodiment, extruding such a low moisture content high starch containing admixture produces pellets or granules used as base material with the pellets or granules having at least 40% starch by pellet or granule weight that preferably have at least 50% starch by pellet or granule weight dextrinizing starch in the admixture during extrusion producing pellets or granules having at least 25% dextrin by pellet or granule weight that preferably have at least 35% dextrin by pellet or granule weight. In yet another preferred embodiment, extruding such a low moisture content high starch containing admixture produces pellets or granules used as base material where the extruded pellets or granules have at least 40% starch by pellet or granule weight that preferably have at least 50% starch by pellet or granule weight dextrinizing starch in the admixture during extrusion producing pellets or granules having at least 30% dextrin by pellet or granule weight that preferably have at least 40% dextrin by pellet or granule weight.

One preferred admixture includes starch-containing corn that can be and preferably is mixed together with at least five percent fiber by total dry admixture weight. The corn can be in the form of whole grain corn and/or degermed corn that can be provided in a ground or comminuted form as corn grits, corn meal, corn flour and/or cornstarch. Where such an admixture includes fiber, the fiber can be wood fiber, rice fiber, oat fiber, wheat fiber and/or another type of fiber that contains at least ten percent insoluble fiber by total dry fiber weight of the fiber added to the admixture. Such a fiber containing admixture advantageously produces granules or pellets that facilitate adhering the granules or pellets tougher, making them more resilient, and more able to withstand impact, shear, and wetting of the granules or pellets during manipulation by a pet or other animal of the finished product such as the toy.

One preferred corn-based admixture is formed of at least 65% by admixture weight of corn that can be ground or otherwise comminuted corn with the remainder being formed of fiber and/or cellulose and/or water added as needed to produce an admixture having a total moisture content of between 7% and 28% by total admixture weight. Another preferred corn-based admixture is formed of at least 70% of such corn with the remainder of the admixture formed of fiber and/or cellulose and/or water added as needed to produce an admixture having a total moisture content of between 7% and 25% by total admixture weight. Still another preferred corn-based admixture is formed of at least 74% of such corn with the remainder of the admixture formed of fiber and/or cellulose and/or water added as needed to produce an admixture having a total moisture content of between 7% and 24% by total admixture weight. One preferred admixture contains between 25-45% of a cornmeal that can be degermed and between 30-60% of another cornmeal that is not degermed. One such preferred admixture also includes between 0-25% fiber such as in the form of rice flour, oat flour, wood fiber or the like. If water is needed, between 0-15% water is added to produce an admixture having a total moisture content less than 30% and preferably less than 25%.

A further another preferred corn-based admixture is formed of at least 85% of such corn with the remainder of the admixture formed of fiber and/or cellulose and/or water added as needed to produce an admixture having a total moisture content of between 7% and 24% by total admixture weight. Still another preferred corn-based admixture is formed of at least 90% of such corn with the remainder of the admixture formed of fiber and/or cellulose and/or water added as needed to produce an admixture having a total moisture content of between 7% and 24% by total admixture weight. Still another preferred corn-based admixture is formed of at least 95% of such corn with the remainder of the admixture formed of fiber and/or cellulose and/or water added as needed to produce an admixture having a total moisture content of between 7% and 24% by total admixture weight. Still another preferred corn-based admixture is formed of at least 98% of such corn with the remainder of the admixture formed of fiber and/or cellulose and/or water added as needed to produce an admixture having a total moisture content of between 7% and 24% by total admixture weight. In one preferred cord-based admixture, the admixture includes 200 pounds of Bunge CCM cornmeal (±35%), 260 pounds of Didion coarse cornmeal (±45%), 100 pounds of Sunopta Rice/Oat flour fiber (±100%), and about 52 pounds of water (±100%) forming an admixture having a total admixture moisture content of no greater than 30% of total admixture weight and preferably between 7.5% and 23% total admixture weight. Such a corn based admixture is extruded in accordance with any of the extrusion methods, extruder pressures and/or extruder temperature disclosed herein into pellets or granules having an average size of between 2 millimeters and 4 millimeters having a bulk density on the order, magnitude or range of the low density pellets/granules bulk density and/or bulk density ranges disclosed above. In one preferred corn based method of extruding pellets, the pellets or granules having an average size between 2-3 mm are extruded forming pellets or granules with a bulk density of between 4-8 pounds per cubic foot and preferably between 5-7 pounds per cubic foot. In another preferred corn based method of extruding pellets, the pellets or granules having an average size between 3-4 mm are extruded forming pellets or granules with a bulk density of between 5-8 pounds per cubic foot and preferably between 6-7.5 pounds per cubic foot.

Another preferred clumped mass formed from extrudate produced from an admixture includes starch-containing sorghum that can also include at least five percent fiber by total dry admixture weight. The sorghum can be red and/or white sorghum in the form of whole grain sorghum and/or degermed sorghum that can be provided as the admixture and/or added to the admixture in a ground or comminuted sorghum meal, sorghum grits, sorghum flour and/or sorghum starch form. Tannins and/or phenolic acid(s) in such a sorghum-containing admixture form a tannin and/or phenolic acid(s) containing extrudate that is formed into tannin-containing and/or phenolic acid(s)-containing granules or pellets advantageously provide the granules or pellets with increased resistance to bacterial growth, fungal growth, yeast growth, and/or virus growth when wetted with liquid. Where such a sorghum-containing admixture also includes fiber, the fiber can be wood fiber, rice fiber, oat fiber, wheat fiber or another type of fiber that contains at least ten percent insoluble fiber by total dry fiber weight of the fiber added to the admixture.

One preferred clumped mass is composed of at least 10% water soluble binder by weight. Other preferred clumped masses are composed of at least 15% water soluble binder, at least 20% water soluble binder, at least 25% water soluble binder, at least 30% water soluble binder, and at least about 35% water soluble binder. In one clumped mass, the water soluble binder is distributed substantially uniformly throughout by weight. Liquid that has been absorbed into the clumped mass during forming can solubilize the binder within the clumped mass forming a flowable adhesive gel that can flow through, from, and out the clumped mass to hold it together as a cohesive mass.

One preferred clumped mass 70 is made from pellets extruded as described hereinabove having water a soluble binder in each extruded pellet or granule formed by or during extrusion with the water soluble binder including at least some dextrin present on or in each extruded pellet or granule that facilitates formation of the clumped mass 70 when the granules or pellets are wetted binder as a binder. One such preferred extruded pellet or granule has a starch content of at least 20%, a dextrin content of at least 5%, and a water soluble binder content of at least 10% by pellet or granule weight after extrusion with the pellets or granules having a moisture content of no greater than 12% at the time when used as base material to form clumps 70. In a preferred starch-containing extruded pellet or granule embodiment, the extruded pellets or granules have a starch content of at least 20%, a dextrin content of at least 8%, and a water soluble binder content of at least 10% by pellet or granule weight where the pellets or granules have a moisture content no greater than 12% when used as base material to form clumps 70. In another preferred starch-containing extruded pellet or granule embodiment, the extruded pellets or granules have a starch content of at least 20%, a dextrin content of at least 10%, and a water soluble binder content of at least 15% by pellet or granule weight where the pellets or granules have a moisture content no greater than 15% when used as base material to form clumps 70. In still another preferred starch-containing extruded pellet or granule embodiment, the extruded pellets or granules have a starch content of at least 30%, a dextrin content of at least 15%, and a water soluble binder content of at least 20% by pellet or granule weight where the extruded pellets or granules have a moisture content no greater than 15% when used as base material to form clumps 70. In yet another preferred starch-containing extruded pellet or granule embodiment, the extruded pellets or granules have a starch content of at least 35%, a dextrin content of at least 20%, and a water soluble binder content of at least 25% by pellet or granule weight where the extruded pellets or granules have a moisture content no greater than 15% when used as base material to form clumps 70. In a further preferred starch-containing extruded pellet or granule embodiment, the extruded pellets or granules have a starch content of at least 40%, a dextrin content of at least 25%, and a water soluble binder content of at least 30% by pellet or granule weight where the extruded pellets or granules have a moisture content no greater than 15% when used as base material to form clumps 70. In a still further preferred starch-containing extruded pellet or granule embodiment, the extruded pellets or granules have a starch content of at least 45%, a dextrin content of at least 30%, and a water soluble binder content of at least 35% by pellet or granule weight where the extruded pellets or granules have a moisture content no greater than 15% when used as base material to form clumps 70. In yet another preferred starch-containing extruded pellet or granule embodiment, the extruded pellets or granules have a starch content of at least 45%, a dextrin content of at least 35%, and a water soluble binder content of at least 40% by pellet or granule weight where the extruded pellets or granules have a moisture content no greater than 15% when used as base material to form clumps 70.

In one such preferred starch-containing extruded pellet or granule embodiment, the extruded pellets or granules used as base material to form clumped masses 70 have a starch content of at least 20%, a dextrin content of at least 8%, and a water soluble binder content of at least 12% by pellet or granule weight where the pellets or granules have a moisture content no greater than 12%. In another such preferred starch-containing extruded pellet or granule embodiment, the extruded pellets or granules have a starch content of at least 20%, a dextrin content of at least 10%, and a water soluble binder content of at least 14% by pellet or granule weight where the pellets or granules have a moisture content no greater than 12%. In still another such preferred starch-containing extruded pellet or granule embodiment, the extruded pellets or granules have a starch content of at least 20%, a dextrin content of at least 15%, and a water soluble binder content of at least 20% by pellet or granule weight where the pellets or granules have a moisture content no greater than 12%. In another such preferred starch-containing extruded pellet or granule embodiment, the extruded pellets or granules used as base material have a starch content of at least 20%, a dextrin content of at least 15%, and a water soluble binder content of at least 20% by pellet or granule weight where the pellets or granules have a moisture content no greater than 15%.

In another such preferred starch-containing extruded pellet or granule embodiment, the extruded pellets or granules have a starch content of at least 20%, a dextrin content of at least 20%, and a water soluble binder content of at least 25% by pellet or granule weight where the pellets or granules have a moisture content no greater than 15%. In still another such preferred starch-containing extruded pellet or granule embodiment, the extruded pellets or granules have a starch content of at least 20%, a dextrin content of at least 25%, and a water soluble binder content of at least 30% by pellet or granule weight where the pellets or granules have a moisture content no greater than 15%.

In still another such preferred starch-containing extruded pellet or granule embodiment, the extruded pellets or granules used as base material have a starch content of at least 30%, a dextrin content of at least 12%, and a water soluble binder content of at least 18% by pellet or granule weight where the pellets or granules have a moisture content no greater than 15% when used as based material and formed into a clumped mass 70 by wetting. In another such preferred starch-containing extruded pellet or granule embodiment, the extruded pellets or granules have a starch content of at least 30%, a dextrin content of at least 18%, and a water soluble binder content of at least 22% by pellet or granule weight where the pellets or granules have a moisture content no greater than 15%. In still another such preferred starch-containing extruded pellet or granule embodiment, the extruded pellets or granules have a starch content of at least 30%, a dextrin content of at least 25%, and a water soluble binder content of at least 35% by pellet or granule weight where the pellets or granules have a moisture content no greater than 15%.

In a further such preferred starch-containing extruded pellet or granule embodiment, the extruded pellets or granules used as at least substantially all of the base material to form clumped masses 70 have a starch content of at least 40%, a dextrin content of at least 10%, and a water soluble binder content of at least 20% by pellet or granule weight where the pellets or granules have a moisture content no greater than 15% at the time when wetted to form a clumped mass 70. In another such preferred starch-containing extruded pellet or granule embodiment, the extruded pellets or granules have a starch content of at least 40%, a dextrin content of at least 20%, and a water soluble binder content of at least 30% by pellet or granule weight where the pellets or granules have a moisture content no greater than 15%. In still another such preferred starch-containing extruded pellet or granule embodiment, the extruded pellets or granules have a starch content of at least 50%, a dextrin content of at least 35%, and a water soluble binder content of at least 45% by pellet or granule weight where the pellets or granules have a moisture content no greater than 15%.

In yet another such preferred starch-containing extruded pellet or granule embodiment, the extruded pellets or granules used in the base material have a starch content of at least 50%, a dextrin content of at least 15%, and a water soluble binder content of at least 20% by pellet or granule weight where the pellets or granules have a moisture content no greater than 15%. In another such preferred starch-containing extruded pellet or granule embodiment, the extruded pellets or granules have a starch content of at least 50%, a dextrin content of at least 15%, and a water soluble binder content of at least 25% by pellet or granule weight where the pellets or granules have a moisture content no greater than 15%. In still another such preferred starch-containing extruded pellet or granule embodiment, the extruded pellets or granules have a starch content of at least 50%, a dextrin content of at least 20%, and a water soluble content of at least 30% by pellet or granule weight where the pellets or granules have a moisture content no greater than 15%.

In yet still another such preferred starch-containing extruded pellet or granule embodiment, the extruded pellets or granules used to form at least 50% of the base material, by formed clumped mass weight, have a starch content of at least 55%, a dextrin content of at least 12%, and a water soluble binder content of at least 20% by pellet or granule weight where the pellets or granules have a moisture content no greater than 12% right before being wetted to form a clumped mass 70. In another such preferred starch-containing extruded pellet or granule embodiment, the extruded pellets or granules have a starch content of at least 55%, a dextrin content of at least 15%, and a water soluble binder content of at least 25% by pellet or granule weight where the pellets or granules have a moisture content no greater than 12%. In still another such preferred starch-containing extruded pellet or granule embodiment, the extruded pellets or granules have a starch content of at least 55%, a dextrin content of at least 18%, and a water soluble binder content of at least 25% by pellet or granule weight where the pellets or granules have a moisture content no greater than 12%.

In a still further such preferred starch-containing extruded pellet or granule embodiment, the extruded pellets or granules used to form at least 75% of the base material, by formed clump mass weight, have a starch content of at least 60%, a dextrin content of at least 14%, and a water soluble binder content of at least 28% by pellet or granule weight where the pellets or granules have a moisture content no greater than 15% right before being wetted form a clumped mass 70. In another such preferred starch-containing extruded pellet or granule embodiment, the extruded pellets or granules have a starch content of at least 60%, a dextrin content of at least 14%, and a water soluble binder content of at least 28% by pellet or granule weight where the pellets or granules have a moisture content no greater than 15%. In still another such preferred starch-containing extruded pellet or granule embodiment, the extruded pellets or granules have a starch content of at least 60%, a dextrin content of at least 18%, and a water soluble binder content of at least 28% by pellet or granule weight where the pellets or granules have a moisture content no greater than 15%. In yet another such preferred starch-containing extruded pellet or granule embodiment, the extruded pellets or granules have a starch content of at least 60%, a dextrin content of at least 20%, and a water soluble binder content of at least 32% by pellet or granule weight where the pellets or granules have a moisture content no greater than 15%. In still yet another such preferred starch-containing extruded pellet or granule embodiment, the extruded pellets or granules have a starch content of at least 60%, a dextrin content of at least 25%, and a water soluble binder content of at least 35% by pellet or granule weight where the pellets or granules have a moisture content no greater than 15%.

In yet still a further such preferred starch-containing extruded pellet or granule embodiment, the extruded pellets or granules used in the base material have a starch content of at least 65%, a dextrin content of at least 15%, and a water soluble binder content of at least 30% by pellet or granule weight where the pellets or granules have a moisture content no greater than 15% when used in the base material and wetted to form a clumped mass 70. In another such preferred starch-containing extruded pellet or granule embodiment, the extruded pellets or granules have a starch content of at least 65%, a dextrin content of at least 25%, and a water soluble binder content of at least 30% by pellet or granule weight where the pellets or granules have a moisture content no greater than 15%. In still another such preferred starch-containing extruded pellet or granule embodiment, the extruded pellets or granules have a starch content of at least 65%, a dextrin content of at least 30%, and a water soluble content of at least 40% by pellet or granule weight where the pellets or granules have a moisture content no greater than 15%.

Referring still to FIG. 6 and with further reference to FIG. 2, one pre preferred panel 27 can be made on-site by an on-site forming of the laminate structural material according to an on-site implementation of the process 200. This can be done by wetting a surface(s) 57 of the substrate material at substrate layer 55 such as by spraying water “W” onto a surface 57 that will face inwardly into the panel 27, when the panel 27 is fully formed. The base material having discrete starch-containing pellets to be bound to each other by a carbohydrate polymer binder is coated onto the wetted substrate material at substrate layer 55, such as by spray application. The application of the base material onto the wetted substrate material activates the forming of a substantially hard or rigid product as the reinforcing layer 60, during which the discrete starch-containing pellets bind to each other within the base material by the carbohydrate polymer binder during curing or drying as explained in greater detail elsewhere herein, forming the laminate structural material 30 in a configuration of the panel 27. Another preferred panel 27 is formed on-site with a sandwiched configuration with the reinforcing layer 60 in between a pair of substrate materials of the layers 55. This can be done by spraying or otherwise applying water “W” to wet the surfaces of a pair of substrate layers 55, coating the wetted substrate material of one of the layers 55 with the base material having discrete starch-containing pellets, and laying the other layer 55 with its wetted surface down to interface with the base material. The discrete starch-containing pellets bind to each other within the base material by the carbohydrate polymer binder during curing or drying for form the laminate structural material 30 and thus the panel 27 on-site.

Regardless of the particular constituents and/or the relative amounts of the constituents, one preferred reinforcing layer 60 with dimensions of about 1 cm×10 cm×10 cm has a crush resistance or compressive strength of at least 75 PSI load at yield. One preferred reinforcing layer 60 with dimensions of about 1 cm×10 cm×10 cm has a crush resistance or compressive strength of at least 100 PSI load at yield, preferably at least 120 PSI load at yield. One preferred reinforcing layer 60 with dimensions of about 1 cm×10 cm×10 cm has a crush resistance or compressive strength of at least 150 PSI load at yield, preferably at least 180 PSI load at yield. Another preferred reinforcing layer 60 with dimensions of about 1 cm×10 cm×10 cm has a crush resistance or compressive strength of at least 200 PSI load at yield, preferably at least 250 PSI load at yield.

One preferred reinforcing layer 60 with dimensions of about 1 cm×10 cm×10 cm has a flexural strength of at least 55 PSI load at yield. One preferred reinforcing layer 60 with dimensions of about 1 cm×10 cm×10 cm has a flexural of at least 75 PSI load at yield, preferably at least 95 PSI load at yield. One preferred reinforcing layer 60 with dimensions of about 1 cm×10 cm×10 cm has a flexural strength of at least 125 PSI load at yield, preferably at least 155 PSI load at yield. Another preferred reinforcing layer 60 with dimensions of about 1 cm×10 cm×10 cm has a flexural strength of at least 175 PSI load at yield, preferably at least 225 PSI load at yield.

One preferred reinforcing layer 60 produces a panel 27 having a pair of substrate layers 55 bonded by the reinforcing layer 60 sandwiched therebetween with panel dimensions of about 1 cm×10 cm×10 cm has a tensile strength of at least 45 PSI load at yield. One preferred reinforcing layer 60 produces a panel 27 having a pair of substrate layers 55 bonded by the reinforcing layer 60 sandwiched therebetween with panel dimensions of about 1 cm×10 cm×10 cm has a tensile of at least 70 PSI load at yield, preferably at least 90 PSI load at yield. Another preferred reinforcing layer 60 produces a panel 27 having a pair of substrate layers 55 bonded by the reinforcing layer 60 sandwiched therebetween with panel dimensions of about 1 cm×10 cm×10 cm has a tensile strength of at least 120 PSI load at yield, preferably at least 150 PSI load at yield. Still another preferred reinforcing layer 60 produces a panel 27 having a pair of substrate layers 55 bonded by the reinforcing layer 60 sandwiched therebetween with panel dimensions of about 1 cm×10 cm×10 cm has a tensile strength of at least 170 PSI load at yield, preferably at least 220 PSI load at yield.

One preferred laminate structural material 30 has a pair of substrate layers 55 and a layer 60 formed of a base material of starch-containing granular material is used to form a laminate panel 27. The layer of starch-containing granular material, e.g., reinforcing layer 60, can include a water soluble binder adhesively bonding the starch-containing granular material together between the substrate layers 55 and adhesively bonding the substrate layers 55 together sandwiching the layer 60 therebetween.

In one preferred laminate structural material 60, the layer of adhesively bonded starch-containing granular material defines a reinforcing layer 60. The reinforcing layer 60 can be disposed between the pair of substrate layers 55 to which the layer 60 of adhesively bonded starch-containing granular material is bonded, which reinforces the pair of substrate layers 55. One preferred layer 60 of adhesively bonded starch-containing granular material has a thickness of at least one-quarter the thickness of one of the pair of substrate layers 55 and no greater than the combined thickness of the pair of substrate layers 55. The starch-containing granular material used to form the laminate panel reinforcing layer 60 can be formed of a base material that includes a plurality of pairs of extruded granules or pellets having at least 20% water soluble binder content by granule or pellet weight. This makes enough water soluble binder available from the pellets or granules are wetted to adhesively bond the granules or pellets together as well as to each one of the pair of substrate layers 55 during making of a laminate panel 27. The starch-containing granular material can be formed of a base material having a plurality of pairs of extruded granules or pellets that contain at least 10% dextrin content by granule or pellet weight. This provides sufficient water soluble binder when wetted to form the reinforcing layer 60 to adhesively bond the granules or pellets together and to each one of the pair of substrate layers 55.

One preferred reinforcing layer 60 defined by the layer of adhesively bonded starch-containing granular material increases the crush strength of the laminate structural material 30 and panel 27 formed of the laminate structural material 30 beyond that of the crush strength of the pair of substrate layers 55 lacking the layer 60 of adhesively bonded starch-containing granular material. One preferred reinforcing layer 60 produced by the adhesively bonded starch-containing granular material increases the bending strength of the laminate structural material 30, and panel 27 formed thereof, beyond that of the bending strength of the pair of substrate layers 55 lacking any layer 60 of adhesively bonded starch-containing granular material. One preferred reinforcing layer 60 defined by the layer of adhesively bonded starch-containing granular material increases the bending strength of the laminate structural material 30 and panel 27 formed thereof, beyond that of the bending strength of the pair of substrate layers 55 without the layer 60 of adhesively bonded starch-containing granular material.

In one preferred laminate structural material 30, the starch-containing granular material forming the base material is formed of a plurality of pairs of extruded granules or pellets having at least 15% dextrin content and at least 25% water soluble binder content by granule or pellet weight formed during pellet or granule extrusion providing sufficient water soluble binder when wetted with water to adhesively bond the granules or pellets together forming the reinforcing layer 60 and to each one of the pair of substrate layers 55 sandwiching the reinforcing layer 60.

One preferred starch-containing granular material is comprised of a plurality of pairs of extruded granules or pellets extruded from an admixture comprised substantially of at least one starch-containing cereal grain. One preferred laminate panel reinforcing layer 60 produced from adhesively bonded starch-containing granular material has a thickness of at least one-quarter the thickness of one of the pair of substrate layers 55 and no greater than the combined thickness of the pair of substrate layers 55.

In one preferred laminate structural material 30, at least one of the pair of substrate layers 55 is formed of paperboard or cardboard. Each one of the pair of substrate layers 55 can be made of paperboard and/or cardboard. One preferred layer of adhesively bonded starch-containing granular material defines a reinforcing layer 60 between the pair of substrate layers 55 to which the layer of adhesively bonded starch-containing granular material is bonded reinforcing the pair of substrate layers 55. Each one of the pair of substrate layers 55 can be made of a generally planar sheet of multi-ply corrugated paperboard or cardboard.

In one preferred laminate structural material 30, the starch-containing granular material is comprised of a plurality of pairs of extruded granules or pellets having at least 10% dextrin content and at least 20% water soluble binder content by granule or pellet weight formed during pellet or granule extrusion. This provides sufficient water soluble binder when wetted with water in forming the reinforcing layer 60 to adhesively bond the granules or pellets together and to each one of the pair of substrate layers 55. One preferred laminate structural material 30 is formed from a base material that includes a starch-containing granular material that has plurality of pairs of extruded granules or pellets extruded from an admixture formed substantially of at least one starch-containing cereal grain.

One preferred laminate structural material 30 includes a pair of substrate layers 55 and a layer 60 of starch-containing granular material disposed between the substrate layers 55. The layer 60 of starch-containing granular material disposed between the substrate layers 55 can be adhesively bonded to the substrate layers 55. One preferred layer 60 of starch-containing granular material is formed by adhesive bonding with water soluble binder from the starch-containing granular material. The layer 60 of starch-containing granular material can define a reinforcing layer 60 between the substrate layers 55 used to form laminate panel 27.

In one preferred laminate structural material 30, the layer of starch-containing granular material has a thickness of at least one-quarter the thickness of one of the pair of substrate layers 55 and no greater than the combined thickness of the pair of substrate layers 55. One preferred laminate structural material 30 is formed from a base material that is formed of a starch-containing granular material that has a plurality of pairs of extruded granules or pellets having at least 20% water soluble binder content by granule or pellet weight. This provides sufficient water soluble binder when the base material is wetted to clump the pellets or granules thereby adhesively bonding the granules or pellets together and to each one of the pair of substrate layers 55. The starch-containing granular material can include a plurality of pairs of extruded granules or pellets having at least 10% dextrin content by granule or pellet weight. This provides sufficient water soluble binder when wetted to adhesively bond the granules or pellets together and to each one of the pair of substrate layers 55. In one preferred laminate structural material 30, each one of the substrate layers 55 includes a generally planar sheet of multi-ply corrugated paperboard or cardboard.

One preferred laminate structural material includes a pair of substrate layers, each formed of a generally planar sheet of cellulosic material. In one preferred laminate structural material, a layer of starch-containing granular material is disposed between the substrate layers and adhesively bonded to the substrate layers when wetted. The layer of starch-containing granular material formed by adhesive bonding with water soluble binder from the starch-containing granular material can be formed during extrusion of the starch-containing granular material. One preferred layer of starch-containing granular material defines a reinforcing layer between the substrate layers.

One preferred layer of the starch-containing granular material has a thickness of at least one-quarter the thickness of one of the pair of substrate layers and no greater than the combined thickness of the pair of substrate layers. One preferred starch-containing granular material includes a plurality of pairs of extruded granules or pellets having at least 10% dextrin content and at least 20% water soluble binder content by granule or pellet weight formed during pellet or granule extrusion providing sufficient water soluble binder when wetted with water. This can adhesively bond the granules or pellets together and to each one of the pair of substrate layers. In one preferred laminate structural material, each generally planar sheet of cellulosic material forms a generally planar sheet of multi-ply corrugated paperboard or cardboard.

One preferred laminate structural material is used for making pet furniture. One preferred laminate structural material is used for making residential or office furniture such as bookshelves or other shelving, tables, and the like. Another preferred laminate structural material is formed into panels that can be implemented as support components. Such panels can be connected to each other forming a structure such as an enclosure. One preferred enclosure formed of the laminate structural material panels is implemented as a temporary shelter such as a temporary shade shelter or windbreak shelter. Another preferred enclosure formed of the laminate structural material is implemented as a temporary emergency shelter or the like. One preferred enclosure formed of the laminate structural material is implemented as a temporary storage shelter or other storage enclosure. One preferred temporary shelter or other structure formed of the laminate structural material can be assembled on-site.

One preferred panel can be made on-site by an on-site forming of the laminate structural material. This can be done by wetting a surface of a substrate material and coating spray application of a base material having discrete starch-containing pellets to be bound to each other by a carbohydrate polymer binder onto the wetted substrate material. The application of the base material onto the wetted substrate material activates the forming of a substantially hard or rigid product as a reinforcing layer, during which the discrete starch-containing pellets bind to each other within the base material by the carbohydrate polymer binder during curing or drying, forming a laminate structural material in a panel configuration.

Another preferred panel is formed on-site or otherwise with a sandwiched configuration with the reinforcing layer in between a pair of substrate materials. This can be done by wetting a surface on each of a pair of substrate materials, coating the wetted substrate material with the base material having discrete starch-containing pellets bound to each other by a carbohydrate polymer binder that dries or cures between and adheres to each of the outwardly disposed substrate materials.

One preferred laminate structural material may include at least one substrate layer and a reinforcing layer. The reinforcing layer may include a binder and starch-containing components. The reinforcing layer may include discrete starch-containing pellets bound to each other by a binder such as a carbohydrate polymer binder. The carbohydrate polymer binder may be water soluble and may include dextrin. The structural material may include at least one cereal grain. The at least one cereal grain may be corn-based. The corn-based at least one cereal grain may include at least one of corn grits, corn meal, corn flour, and corn starch. The at least one substrate layer may include cardboard.

The structural material may include a pair of outer layers and a reinforcing layer arranged between the outer layers. The reinforcing layer may include a binder and at least one starch-containing component. The reinforcing layer may be made from a base material comprising discrete starch-containing pellets bound to each other by a carbohydrate polymer binder.

A structure such as a piece of pet furniture may be made from panels of the laminate structural material. Other furniture, storage containers, and other structures being made from the laminate structural material. The structure may include a support component having the laminate structural material defining at least one outer layer and at least one reinforcing layer. The laminate structural material may include one or more pairs of outer layers and/or reinforcing layers, such as a plurality of pairs, i.e. three or more. One preferred laminate structural material may include a pair of outer layers and a reinforcing layer arranged between the outer layers. The reinforcing layer may be made from a base material that includes discrete starch-containing pellets bound to each other by a carbohydrate polymer binder. The base material from which the reinforcing layers is made may include discrete pellets such as starch-containing pellets bound to each other by a carbohydrate polymer binder. The carbohydrate polymer may be water soluble. The carbohydrate polymer binder may include dextrin. The pellets may be bound to each other with a binder having an acrylic material. Pellets may be bound to each other with a non-acrylic binder which may have a water-activated component. The base material may include a cellulosic material such as hay.

The laminate structural material may allow for use of natural materials that are readily biodegradable or otherwise recyclable, such as cardboard, paperboard, paper, wood, or another suitable substrate, with enhanced structural characteristics for use in making structures, including furniture for pets. This may allow for providing relatively large pieces of pet furniture that are substantially stable and durable by using cost-effective and non-toxic materials

Various alternatives are contemplated as being within the scope of the following claims particularly pointing out and distinctly claiming the subject matter regarded as the invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention. The various contemplated alternatives are not be limited to the embodiments and illustrations contained herein, but the claims should be understood to include modified forms of those embodiments including portions of the embodiments and combinations of elements and/or features of different embodiments within the scope of the following claims.

What is claimed is:

1. A laminate structural material comprising:
(a) a pair of substrate layers; and
(b) a layer of starch-containing granular material comprised of water soluble binder adhesively bonding the starch-containing granular material together between the substrate layers and adhesively bonding the substrate layers together.

2. The laminate structural material of claim 1 wherein the layer of adhesively bonded starch-containing granular material defines a reinforcing layer between the pair of substrate layers to which the layer of adhesively bonded starch-containing granular material is bonded reinforcing the pair of substrate layers.

3. The laminate structural material of claim 2 wherein the layer of adhesively bonded starch-containing granular material has a thickness of at least one-quarter the thickness of one of the pair of substrate layers and no greater than the combined thickness of the pair of substrate layers.

4. The laminate structural material of claim 3 wherein the starch-containing granular material is comprised of a plurality of pairs of extruded granules or pellets having at least 20% water soluble binder content by granule or pellet weight providing sufficient water soluble binder when wetted to adhesively bond the granules or pellets together and to each one of the pair of substrate layers.

5. The laminate structural material of claim 3 wherein the starch-containing granular material is comprised of a plurality of pairs of extruded granules or pellets having at least 10% dextrin content by granule or pellet weight providing sufficient water soluble binder when wetted to adhesively bond the granules or pellets together and to each one of the pair of substrate layers.

6. The laminate structural material of claim 2 wherein the reinforcing layer defined by the layer of adhesively bonded starch-containing granular material increases the crush strength of the laminate structural material beyond that of the crush strength of the pair of substrate layers without the layer of adhesively bonded starch-containing granular material.

7. The laminate structural material of claim 2 wherein the reinforcing layer defined by the layer of adhesively bonded starch-containing granular material increases the bending strength of the laminate structural material beyond that of the bending strength of the pair of substrate layers without the layer of adhesively bonded starch-containing granular material.

8. The laminate structural material of claim 2 wherein the reinforcing layer defined by the layer of adhesively bonded starch-containing granular material increases the bending strength of the laminate structural material beyond that of the bending strength of the pair of substrate layers without the layer of adhesively bonded starch-containing granular material.

9. The laminate structural material of claim 1 wherein the starch-containing granular material is comprised of a plurality of pairs of extruded granules or pellets having at least 15% dextrin content and at least 25% water soluble binder content by granule or pellet weight formed during pellet or granule extrusion providing sufficient water soluble binder when wetted with water to adhesively bond the granules or pellets together and to each one of the pair of substrate layers.

10. The laminate structural material of claim 9 wherein the starch-containing granular material is comprised of a plurality of pairs of extruded granules or pellets extruded from an admixture comprised substantially of at least one starch-containing cereal grain.

11. The laminate structural material of claim 9 wherein the layer of adhesively bonded starch-containing granular material has a thickness of at least one-quarter the thickness of one of the pair of substrate layers and no greater than the combined thickness of the pair of substrate layers.

12. The laminate structural material of claim 1 wherein at least one of the pair of substrate layers is comprised of paperboard or cardboard.

13. The laminate structural material of claim 12 wherein each one of the pair of substrate layers is comprised of paperboard or cardboard.

14. The laminate structural material of claim 12 wherein the layer of adhesively bonded starch-containing granular material defines a reinforcing layer between the pair of substrate layers to which the layer of adhesively bonded starch-containing granular material is bonded reinforcing the pair of substrate layers.

15. The laminate structural material of claim 14 wherein each one of the pair of substrate layers is comprised of a generally planar sheet of multi-ply corrugated paperboard or cardboard.

16. The laminate structural material of claim 14 wherein the starch-containing granular material is comprised of a plurality of pairs of extruded granules or pellets having at least 10% dextrin content and at least 20% water soluble binder content by granule or pellet weight formed during pellet or granule extrusion providing sufficient water soluble binder when wetted with water to adhesively bond the granules or pellets together and to each one of the pair of substrate layers.

17. The laminate structural material of claim 16 wherein the starch-containing granular material is comprised of a plurality of pairs of extruded granules or pellets extruded from an admixture comprised substantially of at least one starch-containing cereal grain.

18. A laminate structural material comprising:
(a) a pair of substrate layers; and
(b) a layer of starch-containing granular material disposed between the substrate layers and adhesively bonded to the substrate layers, the layer of starch-containing granular material formed by adhesive bonding with water soluble binder from the starch-containing granular material, and the layer of starch-containing granular material defining a reinforcing layer between the substrate layers.

19. The laminate structural material of claim 18 wherein the layer of starch-containing granular material has a thickness of at least one-quarter the thickness of one of the pair of substrate layers and no greater than the combined thickness of the pair of substrate layers.

20. The laminate structural material of claim 18 wherein the starch-containing granular material is comprised of a plurality of pairs of extruded granules or pellets having at least 20% water soluble binder content by granule or pellet weight providing sufficient water soluble binder when wetted to adhesively bond the granules or pellets together and to each one of the pair of substrate layers.

21. The laminate structural material of claim 18 wherein the starch-containing granular material is comprised of a plurality of pairs of extruded granules or pellets having at least 10% dextrin content by granule or pellet weight providing sufficient water soluble binder when wetted to adhesively bond the granules or pellets together and to each one of the pair of substrate layers.

22. The laminate structural material of claim 18 wherein each one of the substrate layers is comprised of a generally planar sheet of multi-ply corrugated paperboard or cardboard.

23. A laminate structural material comprising:
(a) a pair of substrate layers each comprised of a generally planar sheet of cellulosic material; and
(b) a layer of starch-containing granular material disposed between the substrate layers and adhesively bonded to the substrate layers when wetted, the layer of starch-containing granular material formed by adhesive bonding with water soluble binder from the starch-containing granular material formed during extrusion of the starch-containing granular material, and the layer of starch-containing granular material defining a reinforcing layer between the substrate layers.

24. The laminate structural material of claim 23 wherein the layer of starch-containing granular material has a thickness of at least one-quarter the thickness of one of the pair of substrate layers and no greater than the combined thickness of the pair of substrate layers.

25. The laminate structural material of claim 24 wherein the starch-containing granular material is comprised of a plurality of pairs of extruded granules or pellets having at least 10% dextrin content and at least 20% water soluble binder content by granule or pellet weight formed during pellet or granule extrusion providing sufficient water soluble binder when wetted with water to adhesively bond the granules or pellets together and to each one of the pair of substrate layers.

26. The laminate structural material of claim 25 wherein each generally planar sheet of cellulosic material is comprised of a generally planar sheet of multi-ply corrugated paperboard or cardboard.
